(19) United States
(12) Patent Application Publication
(10) Pub. No.: US 2006/0212810 A1
(43) Pub. Date: Sep. 21, 2006

(54) Method and apparatus for generating correspondence

(76) Inventors: Lynn F. Segal, Chestnut Hill, MA (US); Jules M. Fried, Brookline, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/080,349

(22) Filed: Mar. 15, 2005

(51) Int. Cl. G06F 17/00; G06F 17/30

(52) U.S. Cl. 715/530; 707/1

(57) ABSTRACT

A system is provided for creating documents, and in particular, for creating individualized personal documents for use with marketing activities such as fundraising, direct mail, campaigns, etc. Specifically, a capability may be provided for creating documents that include a portion generated by an individual and one or more portions generated by an organization. Further, a process is provided for creating a document that reduces the iterations between an individual writer and the organization with which the individual is writing letters on their behalf. In one example, the process includes a single-pass where the individual creates individualized personal information for inclusion in a document, yet the document includes pre-approved text that cannot be changed by the individual.

### FIELD OF THE INVENTION

The invention relates generally to systems for work flow automation, and more particularly to systems and methods for generating correspondence.

### BACKGROUND

There are many systems for creating correspondence, including word processing programs that are used by individual users to create documents (e.g., letters). Many of these systems permit a user to begin with a template as a basis for creating a custom document. There also exist more elaborate systems for creating documents which include workflow management features. These conventional systems allow individuals to share documents electronically, edit, and add comments to documents as necessary.

There are many different systems used by organizations for creating mail for customers. In particular, there are a number of products that enable mass creation of custom letters and emails for direct marketing. Typically, mail merge technology is used to create content relevant to a customer that receives such marketing information. For example, mail merge technology enables matching pre-drafted content to a recipient based on pre-selected demographic characteristics such as zip code, income level, or other data. Direct mail using such mail merge technology is used for many different activities, including fundraising, political campaigns, direct marketing, among others.

Mail merge technology generally includes a programming feature of a document creation program that allows automatic creation of multiple custom instances of a document. Such creation is performed by substituting different text strings drawn from a database in place of certain field markers in a document template. For instance, the address, salutation, and other information may be extracted or inferred from entries in a database (e.g., a mailing address database) and inserted into the document template. An instance of the document is created and sent to a recipient (e.g., a customer). Such documents created by mail merge technology, although customized based on demographic information, generally are not personalized, and are used typically for mass mailings, spam, and other applications involving a large number of recipients.

An alternative approach to mail merge technology includes marketing “kits” provided by organizations to individuals for performing direct marketing functions. Specifically, such organizations assemble folders of cards, return inserts, and envelopes as kits which are sent to volunteers who are asked to write a brief personal note by hand or add a personal post-script to a prewritten note, then assemble the other pieces of the kit and either deliver by hand or send out mailings. Such direct marketing methods are generally more effective, as the volunteer is able to leverage their personal relationship with the recipient to generate results. However, such methods are time and labor intensive, and are not well-suited for contacting large numbers of recipients. Moreover, rates at which recipients “follow through” with a response, donation, etc. are low.

Another labor-intensive approach includes requesting multiple individuals affiliated with an organization to manually create letters which are then sent to direct mail recipients. The existing, known practice of creating separate, custom (but not crafted with information personal to the individual) letters involves the production of a software template letter that is first sent, either electronically or in hard copy, to letter writers for review and editing. Then, each writer sends each letter back to the organization with comments and corrections. Typically, there are multiple edit cycles performed between the organization and the individual letter writer, increasing the amount of time spent on the letter-writing process.

After the letter or other document template is finalized, the organization merges the template letter with the addresses for recipients that the particular volunteer is going to write. Completed letters are typically returned to the writer as a computer file. At that point, the letter writer reviews each letter individually and adds, modifies or adjusts various personal items, perhaps cutting and pasting from other letters or previous correspondence. The file with the individual letters is then sent back to the organization for printing on the organization's stationary. Often, the printed letters are once again returned to the volunteer for signing, and possibly adding an individualized hand-written post-script. The letters are then again returned to the organization for folding, stamping, and mailing.

### SUMMARY OF THE INVENTION

According to one aspect of the present invention, it is realized that there are many deficiencies in current methods for preparing correspondence. In particular, current mail merge technology is premised on the one-to-many model having one sender to many recipients. As a result of this model, such correspondence is customized based on certain characteristics, but the correspondence is not personal. According to one aspect of the present invention, it is recognized that personal letters to a recipient are more effective than conventional customized letters, and it would be beneficial to provide an easier method and system to generate more personal correspondence.

Also, according to another aspect of the present invention, it is realized that the complexity and labor intensiveness of the above document creation processes make the application of these techniques limited. For instance, although the use of templates is aimed to save time in preparing documents, individuals often need to write a majority of letters on their own, with little to no reduction in effort provided by the templates. Conventional correspondence generators may hold commonly-used letter text or templates which can be accessed by the individual user, but such a system only provides a mechanism for users to cut, paste and edit pre-existing text; writers are required to edit and perform multiple copy/paste operations from other documents. Further, conventional methods for creating documents necessitates multiple review cycles between the organization and the individual user, causing additional delay and effort. Also, the final number of correspondence sent is usually a small fraction of the total number expected due to the highly iterative nature of the process and abandonment of the effort on behalf of the individuals. Therefore, an improved method is needed for creating personalized correspondence in such a distributed organization setting.

According to one aspect of the present invention, a system and method is provided for generating correspondence. According to one aspect, a method for users is provided that allows users to produce correspondence (e.g., letters) between themselves and multiple recipients that can be printed and mailed, without requiring multiple review iterations. According to one embodiment, a single-pass method of creating a document is provided that permits inclusion of individual information from the user, the information being specific to that user's relationship with the individual recipient of the letter. Further, the method may allow an organization to include preapproved text that cannot be changed by the user. In this manner, correspondence need not be reviewed by the organization, and personal documents may be created more quickly.

Also, it is appreciated that there are multiple conventional methods using mail-merge technology, including database driven methods, to personalize volumes of letters to individuals based on pre-existing data that is “mined” for information that is then used to select appropriate text for individuals meeting pre-determined criteria. However, none of these methods provide a real-time tool for creation of individualized letters based on the knowledge of the individual writer and relationship to the recipient. According to one aspect of the present invention, it is realized that truly personal correspondence is more effective than database-driven methods for performing certain activities such as fundraising activities. To this end, it would be beneficial to have a method for quickly and efficiently generating personal correspondence. Each resulting letter generated as a result of such a method may be unique, similar to any truly personal correspondence. Such correspondence, although useful for fundraising activities, may also be used in other activities including customer communications. Example correspondences may include sales material, proposals, client welcome letters, and the like.

According to one aspect of the present invention, a computer-based method is provided for creating a document in a computer system. The method comprises acts of a) providing, to a user, an interface that allows the user to create at least one first content portion, b) providing, by an organization, at least one second content portion, and c) generating the document including the at least one first content portion and at least one second content portion. According to one embodiment of the invention, the method further comprises an act of collecting content from the user in a sequence of steps. According to another embodiment, the act of collecting content further comprises collecting the content in a linear sequence of steps.

According to another embodiment, the document is a letter, and the method further comprises an act of sending, by the organization, the letter to a recipient. According to another embodiment, the method further comprises an act of permitting the user to print the document at a computer system. According to another embodiment, the acts a) through c) are performed by a computer system coupled to a communications network.

According to another embodiment, the method further comprises an act of designating the at least second portion as unchangeable by the user. According to another embodiment, the method further comprises an act of storing the at least first content portion in a database. According to another embodiment, the at least one second portion includes a portion of text written in a first voice, and wherein the method further comprises an act of permitting the user to change the first voice to a second voice. According to another embodiment, the at least one second portion further comprises a portion of substantive content, and wherein a changing of the first voice to the second voice does not change the portion of substantive content.

According to another embodiment, the act of generating does not include an act of modifying the document after the act of generating. According to another embodiment, the method further comprises an act of retrieving the at least first content portion from the database for use in a subsequent document. According to another embodiment, the computer system includes a first computer system operated by the user, and wherein the method further comprises an act of transmitting the document to the organization. According to another embodiment, the method further comprises acts of printing and mailing the document by the organization.

According to another embodiment, the computer system includes a first computer system operated by the user, and wherein the method further comprises an act of printing the document by the first computer system, and mailing, by the user, the document to a recipient. According to another embodiment, the method further comprises an act of generating an event to the organization indicating that the document has been mailed.

According to another embodiment, the method further comprises an act of storing a status of an action required by at least one of the organization, the user, and a recipient of the document. According to another embodiment, the method further comprises an act of generating an event based on the status of the action required. According to another embodiment, the act of generating an event further comprises an act of sending, to the at least one of the organization, the user, and the recipient of the document, an indication of the status of the action required. According to another embodiment, the act of sending an indication includes an act of sending an e-mail including the indication. According to another embodiment, the act a) of providing further comprises an act of presenting an example content portion that may be edited by the user to create the at least one first content portion. According to another embodiment, the at least one first content portion includes information personal to a relationship of the user to a recipient of the document.

According to another embodiment, the method further comprises acts of retrieving the at least one first content portion from the database, inserting the at least one first content portion in a field of a template, and storing an instance of the template, the instance including that at least one first content portion.

According to another aspect of the present invention, a computer-readable medium is provided having computer-readable signals stored thereon that define instructions that, as a result of being executed by a computer, instruct the computer to perform a method for creating a document. The method comprises acts of a) providing, to a user, an interface that allows the user to create at least one first content portion, b) providing, by an organization, at least one second content portion, and c) generating the document including the at least one first content portion and at least one second content portion. According to one embodiment of the invention, the method further comprises an act of collecting content from the user in a sequence of steps. According to another embodiment, the act of collecting content further comprises collecting the content in a linear sequence of steps. According to another embodiment, the document is a letter, and the method further comprises an act of sending, by the organization, the letter to a recipient. According to another embodiment, the method further comprises an act of permitting the user to print the document at a computer system.

According to another embodiment, the acts a) through c) are performed by a computer system coupled to a communications network. According to another embodiment, the method further comprises an act of designating the at least second portion as unchangeable by the user. According to another embodiment, the method further comprises an act of storing the at least first content portion in a database.

According to another embodiment, the at least one second portion includes a portion of text written in a first voice, and wherein the method further comprises an act of permitting the user to change the first voice to a second voice. According to another embodiment, the at least one second portion further comprises a portion of substantive content, and wherein a changing of the first voice to the second voice does not change the portion of substantive content.

According to another embodiment, the act of generating does not include an act of modifying the document after the act of generating. According to another embodiment, the method further comprises an act of retrieving the at least first content portion from the database for use in a subsequent document.

According to another embodiment, the computer system includes a first computer system operated by the user, and wherein the method further comprises an act of transmitting the document to the organization. According to another embodiment, the method further comprises acts of printing and mailing the document by the organization. According to another embodiment, the computer system includes a first computer system operated by the user, and wherein the method further comprises an act of printing the document by the first computer system, and mailing, by the user, the document to a recipient.

According to another embodiment, the method further comprises an act of generating an event to the organization indicating that the document has been mailed. According to another embodiment, the method further comprises an act of storing a status of an action required by at least one of the organization, the user, and a recipient of the document. According to another embodiment, the method further comprises an act of generating an event based on the status of the action required. According to another embodiment, the act of generating an event further comprises an act of sending, to the at least one of the organization, the user, and the recipient of the document, an indication of the status of the action required. According to another embodiment, the act of sending an indication includes an act of sending an e-mail including the indication. According to another embodiment, the act a) of providing further comprises an act of presenting an example content portion that may be edited by the user to create the at least one first content portion. According to another embodiment, the at least one first content portion includes information personal to a relationship of the user to a recipient of the document.

According to another embodiment, the method further comprises acts of retrieving the at least one first content portion from the database, inserting the at least one first content portion in a field of a template, and storing an instance of the template, the instance including the at least one first content portion.

Further features and advantages of the present invention as well as the structure and operation of various embodiments of the present invention are described in detail below with reference to the accompanying drawings. In the drawings, like reference numerals indicate like or functionally similar elements. Additionally, the left-most one or two digits of a reference numeral identifies the drawing in which the reference numeral first appears.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a block diagram of a general-purpose computer system suitable for practicing various embodiments of the present invention;

FIG. 2 shows a block diagram of a system according to one embodiment of the present invention;

FIG. 3 shows a process for creating a document according to one embodiment of the present invention;

FIG. 4 shows a process for creating a document according to another embodiment of the present invention;

FIG. 5 shows an interface that may be used to create documents according to one embodiment of the present invention;

FIG. 6 shows an interface that may be used to create documents according to another embodiment of the present invention;

FIG. 7 shows an interface that may be used to create documents according to another embodiment of the present invention;

FIG. 8 shows an interface that may be used to create documents according to another embodiment of the present invention;

FIG. 9 shows an interface that may be used to create documents according to another embodiment of the present invention;

FIG. 10 shows an interface that may be used to create documents according to another embodiment of the present invention; and

FIG. 11 shows an interface that may be used to create documents according to another embodiment of the present invention.

### DETAILED DESCRIPTION

As discussed above, one aspect of the present invention relates to system and methods for creating documents, and in particular, for creating truly personal documents for use with marketing activities such as fundraising, direct mail, campaigns, etc. Such a system and methods may be capable of creating documents that include a portion generated by an individual and one or more portions generated by an organization.

Another aspect of the invention relates to a process for creating a document. More specifically, a process for creating a document is provided that reduces the iterations between an individual writer and the organization with which the individual is writing letters on their behalf. In one example, the process includes a single-pass where the individual creates individualized information that is personal to the sender/recipient for inclusion in a document, yet the document includes pre-approved text that cannot be changed by the individual.

Such individualized information may include any information known as a result of the relationship between the sender and recipient. For instance, the individualized information may include personal information about the recipient that the sender knows through the relationship, or may be other information relating to contacts between the sender and recipient. In one example, the sender may include information relating to a previous meeting between the sender and receiver. Other information may be included that is highly specific to the relationship between the sender and recipient.

The system may be adapted to display, to the user, information relating to the composition of a document, such as correspondence including letters, postcards, e-mails and the like. Such information may include, for example, portions of the document. These portions may be, for example, portions of text that can be personalized by the individual writing the document. In one embodiment, the system is capable of storing portions previously developed, and the system may enable a user to select portions of these portions for use in developing a new document. Portions may be created and edited by a user (e.g., a writer) in a stepwise manner, thus simplifying the task of creating documents such as correspondence. As a result, the time and effort to create the correspondence is minimized.

According to one embodiment, a system is provided that allows an organization to “post” proposed portions (e.g., body text of an example correspondence) for a new correspondence where individual writers can access the proposed portions to incorporate into the new correspondence. Such content may be accessed, for example, by a writer through a web-based interface.

Writers may use the proposed text “as is” or may modify the text to suit their particular writing or communication style. For example, portions such as salutation, greeting name, opening, closing, complimentary close and post-scripts may be personalized so that the correspondence appears to the writer and recipient to have been created specifically for the individual recipient from an individual writer. In another example, passages, full sentences, or other sections of text can be “frozen” so that they cannot be modified by the writer, allowing an organization to control the way in which a particular subject is described, while at the same time providing the writer free reign to rewrite other portions.

A “switch” or other type of control may be provided that permits the writer to change the voice of the correspondence to reflect whether they are writing as an individual (the “I” voice) or as a couple or family unit (the “we” voice). Similarly, organizations can choose to send (e.g., by printing and mailing) correspondence centrally on behalf of the letter-writer or the writer can send the correspondence (e.g., by printing at their local printer and mailing) the correspondence themselves. Further, in another example, the system may provide automated triggers and alerts to allow organizations to manage the correspondence writing effort with minimal staff intervention.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to create documents according to various embodiments of the invention. Further, the system may be located on a single computer or may be distributed among a plurality of computers attached by a communications network.

A general-purpose computer system according to one embodiment of the invention is configured to perform any of the described document creation functions including but not limited to collecting text and other input from a user, storing one or more portions of document, etc. It should be appreciated that the system may perform other functions, including storing and/or managing information used in generating documents, and the invention is not limited to having any particular function or set of functions.

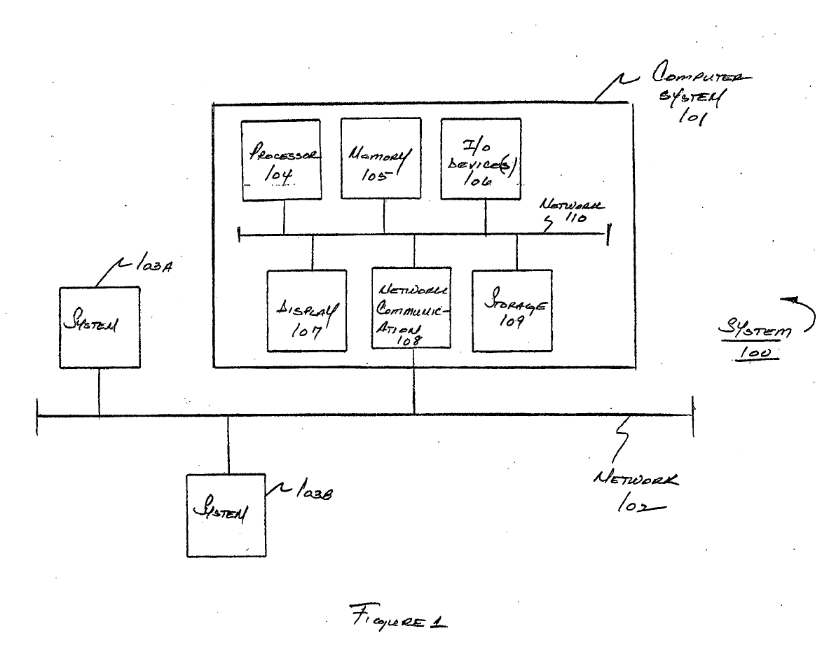

FIG. 1 shows a block diagram of a general purpose computer and network system in which various aspects of the present invention may be practiced. For example, various aspects of the invention may be implemented as specialized software executing in one or more computer systems including general-purpose computer system 101 shown in FIG. 1. Computer system 101 may include a processor 104 connected to one or more memory devices 105, such as a disk drive, memory, or other device for storing data. Memory 105 is typically used for storing programs and data during operation of the computer system 101. Components of computer system 101 may be coupled by an interconnection mechanism such as network 110, which may include one or more busses (e.g., between components that are integrated within a same machine) and/or a network (e.g., between components that reside on separate discrete machines). The interconnection mechanism enables communications (e.g., data, instructions) to be exchanged between system components of system 101.

Computer system 101 also includes one or more input/output (I/O) devices 106, for example, a keyboard, mouse, trackball, microphone, touch screen, a printing device, display screen, speaker, etc. In addition, computer system 101 may contain one or more interfaces (e.g., network communication device 108) that connect computer system 101 to a communication network (in addition or as an alternative to the network 110.

The storage system 109, typically includes a computer readable and writeable nonvolatile recording medium in which signals are stored that define a program to be executed by the processor or information stored on or in the medium to be processed by the program. The medium may, for example, be a disk or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). The memory may be located in storage system 109, as shown, or in memory system 105. The processor 104 generally manipulates the data within the integrated circuit memory 104, and then copies the data to the medium associated with storage 109 after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 101 is shown by way of example as one type of computer system upon which various aspects of the invention may be practiced, it should be appreciated that aspects of the invention are not limited to being implemented on the computer system as shown in FIG. 1. Various aspects of the invention may be practiced on one or more computers having a different architectures or components than that shown in FIG. 1.

Computer system 101 may be a general-purpose computer system that is programmable using a high-level computer programming language. Computer system 101 may be also implemented using specially programmed, special purpose hardware. In computer system 101, processor 104 is typically a commercially available processor such as the well-known Pentium class processor available from the Intel Corporation. Many other processors are available. Such a processor usually executes an operating system which may be, for example, the Windows-based operating systems (e.g., Windows NT, Windows 2000 (Windows ME), Windows XP operating systems) available from the Microsoft Corporation, MAC OS System X operating system available from Apple Computer, the Solaris operating system available from Sun Microsystems, or UNIX operating systems available from various sources. Many other operating systems may be used, and the invention is not limited to any particular operating system.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems (e.g., servers) configured to provide a service to one or more client computers, or to perform an overall task as part of a distributed system. For example, various aspects of the invention may be performed on a client-server or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting (e.g., JavaScript), and/or logical programming languages (e.g., C) may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Various aspects of this system can be implemented by one or more systems within system 100. For instance, the system may be a distributed system (e.g., client server, multi-tier system). In one example, the system 200 includes software processes executing on a system associated with a user (e.g., system 202) and a system that manages the document creation process (e.g., system 201). One or more users 203 (e.g., a user, administrator, other member of an organization, etc.) may be able to create documents such as correspondence using one or more systems (e.g., system 202) through an interface provided by system 201. These systems may display information relating to the document creation process for display, for example, to various users including a writer, an administrator or other person affiliated with an organization, among others. In a particular example, a writer can add personal information to documents (e.g., correspondence such as letters) and may be permitted to manage activities related to the correspondence (e.g., such as follow-up, printing, managing contacts, etc.). In another example, the administrator may be permitted to view the status of the document generation process, follow-up activities, and generate reports.

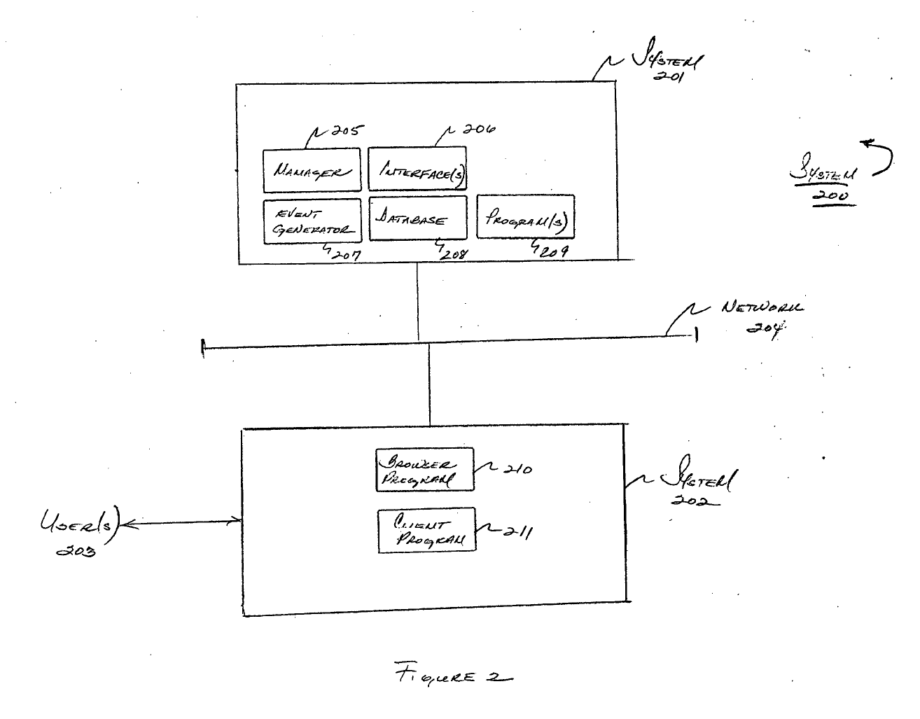

FIG. 2 shows an architecture diagram of a document creation and management system 200 according to one embodiment of the invention. System 200 may include, for example, a server-based system (e.g., system 201) coupled to a client system (e.g., system 202) through a communication network 204. Systems 200, 201 may be, for example, general purpose computer systems coupled through one or more networks including the Internet. Systems 200, 201 may include one or more components that perform functions relating to the document management system.

In one specific example, system 201 may be a general-purpose computer system that includes one or more program components that implement functions of the document management system. For instance, system 201 may include a database component 208 and its associated databases that store portions of documents for use in creating document and status information relating to the document management process and its related functions. In one example, the database may be a relational-type SQL database available commercially from various companies including the Oracle Corporation, MySQL AB, and others. It should be appreciated, however, that any database structure may be used (e.g., object database, file system, etc.), and the invention is not limited to any particular type of database.

System 201 may also include one or more programs 209 that are used by a client computer to access the document management system. These programs may be, for example, programs that may be downloaded to a client system (e.g., system 202) as client programs 211 and executed. In one specific example, the programs 211 are programs that are interpreted (e.g., Java-based programs) and/or scripts that are executed within a browser program 210 on the client. However, it should be appreciated that programs 211 may be written in any programming language(s), and the invention is not limited to any particular implementation.

Server system 201 may also include a manager 205 program that executes management functions associated with the document management process. Manager program 205 may be a program executed by server system 201, and may be written in one or more programming languages. For instance, program 205 may be written as a Java program executing on the server (e.g., a servlet). In another example, the well-known .NET framework available from Microsoft may be used. In one specific example, the ASP.NET framework (Active Server Pages) which is a server-side scripting environment that can be used to create and run dynamic, interactive web-based server applications. Although various aspects of the invention may be developed using .NET and/or Active Server Pages, it should be appreciated that any programming language, framework, or environment may be used, and the invention is not limited to any particular implementation. For example, various aspects of the invention may be implemented in the J2EE framework available from Sun Microsystems, Inc. Manager 205 is configured to use and store information in database component 208 relating to the status and creation of documents.

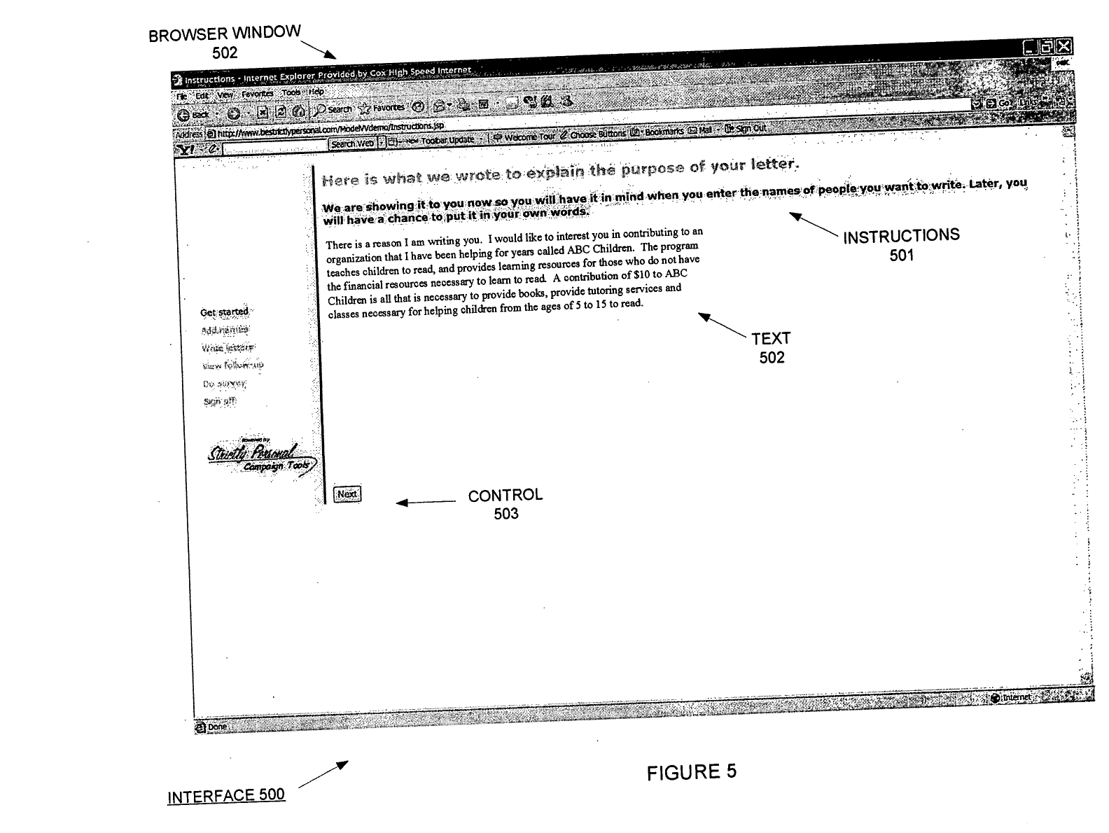

Client program 211 may include one or more user interface components that accept or display information to one or more users 203. These user interface components may be, for example, programmed using Windows forms, available from the Microsoft Corporation. These user interface components may control how information is displayed and received through the user interfaces to users 203. Such interfaces may be downloaded as part of client program 211 and displayed at a client system (e.g., system 202). Various user interfaces and their features are discussed in more detail below with respect to FIGS. 5-11. In association with such interfaces may be one or more fields in which a user may add and/or edit a portion of a document.

Associated with manager 205 may be one or more interface programs 206 that permit an administrator to manage the document creation process and any related functions associated with managing relationships between the writer, the organization, and recipients. These interface programs 206 may include, for example, the interfaces discussed above, written in one or more programming languages. In one example, such interface programs 206 are web-based programs that are downloaded and executed in a browser interface.

System 201 may also include an event generator 207 program that is configured to generate events upon request by manager 205. Such a generator 207 may, for example, generate e-mail messages to administrators, writers, and other entities in support of the document management process. According to one embodiment, event generator 207 may generate an event based on a status of an action required by a writer, administrator, recipient, or other user role within the system. For example, the event generator may prompt an e-mail system to send to a user of the system (e.g., the organization, the writer, the recipient of the document, etc.) an indication of the status of the action required. These actions may be stored, for example, in a database component 208 located on server 201.

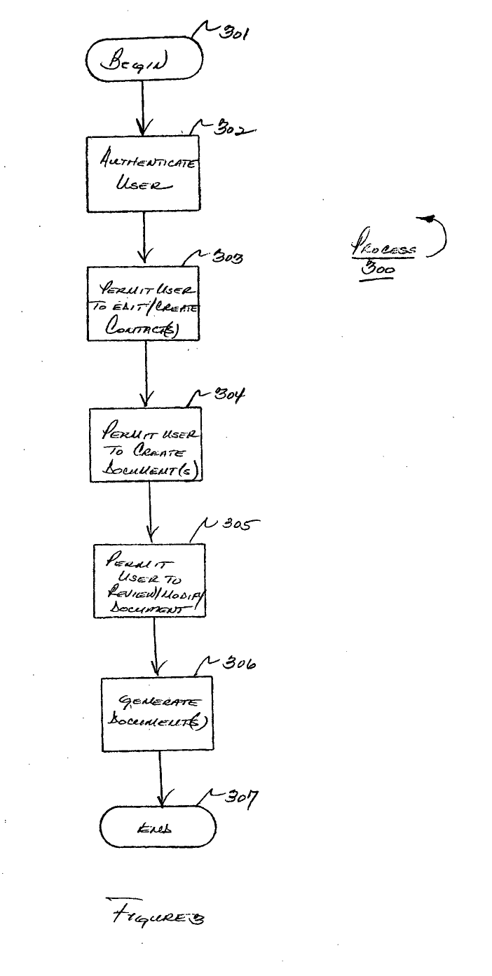

FIG. 3 shows a process 300 for creating a document according to one embodiment of the present invention. At block 301, process 300 begins. At block 302, a user such as a writer or author of the document authenticates to the document management system. This may be accomplished, for example, by the user entering a user name and password in an interface presented in an interface of a client system (e.g., system 202).

The user, once authenticated, may be permitted to perform one or more functions relating to managing the document creation process. For instance, at block 303, the user may be permitted to enter information relating to one or more contact(s). Such contacts may be potential recipients of correspondence generated through the system. After creation, the user may be permitted to select one or more contacts to which correspondence may be created. Alternatively, the organization may provide a list of contacts to the writer from which the writer may select one or more recipients.

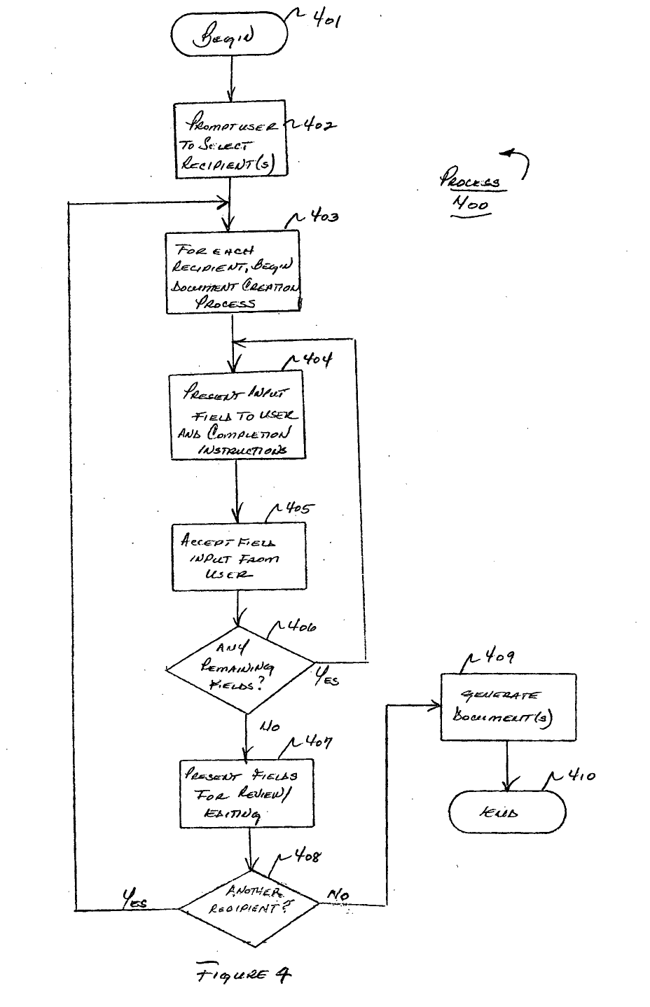

At block 304, the user is permitted to create one or more documents to contacts created at block 303. One such document creation process is described below with reference to FIG. 4. According to one embodiment of the present invention, the writer creates a document in a single pass, without the need for transferring the document between the writer and the organization for review and editing. In this manner, the amount of time necessary for producing correspondence is reduced.

At block 305, the user is permitted to review and/or modify the document. The document, once approved by the writer, is ready to be generated at block 306. The document may be generated electronically and sent to the organization for printing, addressing, and mailing, or may be locally printed by the writer and sent. At block 307, process 300 ends.

Optionally, process 300 may include one or more follow-up activities, such as printing and/or sending documents, generating surveys to users regarding feedback on the document creation process, performing workflow management functions, and storing and reporting statuses on correspondences. It should be appreciated that process 300 may include more or less acts, and the invention is not limited to the acts shown by way of example.

FIG. 4 shows an example document creation process 400 according to one embodiment of the present invention. More particularly, FIG. 4 shows a more specific example of a document creation process such as that shown in FIG. 3. In the example, the document-writing process is de-constructed into its component parts, and the user (e.g., a writer) is walked through each step, and is invited and encouraged to personalize each section of the document as much as possible. In one example, suggestions are provided by the system to the writer to instruct the writer on how various sections of the letter may be written. Pre-drafted body text may be provided for a writer to accept as is or edit as desired. Text or other portions of the document (e.g., portions that the organization does not want the individual user to change) may be “frozen” so that the portions appear in the resulting document as intended.

At block 401, process 400 begins. At block 402, a client program (e.g., program 211) prompts the user (e.g., a writer) to select a recipient of a document, such as a letter. For each recipient, a document creation process is followed at block 403. According to one aspect of the present invention, a document is created and generated in a single pass, without requiring multiple edit and review processes between a writer and an organization. To this end, there may be pre-approved text which may be inserted in the document. Such text may be previously approved by the organization for inclusion in the document. The writer is permitted to add his/her own individualized text, which causes the document to become individualized toward the recipient. In this manner, an efficient method is provided to produce timely, yet truly personal correspondence.

Information is collected by the program (e.g., program 211) by presenting the user an interface (e.g., a Windows form, HTML form, or other interface) in which the user may enter information for inclusion in the document. In particular, the interface may present one or more fields to the user for completion. These fields may correspond to sections in a document, such as, for example, a salutation, introduction, body, closing, etc. With each presentation of a field to be completed by the user, instructions may be presented to the user for their completion. In another example, these instructions may include example text that may be used by the user as exemplary content that may be further customized by the user to suit. In a particular example, the example text may be provided to be modified by the user (e.g., individualized to reflect the personal relationship between the writer and recipient). In particular, the field may be pre-populated with example text which can be deleted/changed by the user.

At block 405, the user provides input to the field being presented, and allows the input to be submitted to the system. The system, upon receiving the information, may store the information in a database (e.g., database 208 on system 201). At block 406, it is determined (e.g., by program 211) whether there are any fields remaining for the user to provide input. If so, another interface is presented to the user, with the remaining field and any associated instructions for completion. If not, the user may be presented an optional step of reviewing what was previously written, and if necessary, editing what was previously written at block 407.

After the document content has been approved by the user, the program determines if there are any additional recipients to whom correspondence needs to be sent. If there are additional recipients, additional document creation processes are performed at block 403. If not, the document(s) previously created by the user are generated at block 409. These documents may be generated, for example, in any number of formats (e.g., RTF, Microsoft Word, Adobe PDF). In one example, information stored in the database is retrieved and sent to fields of a template (e.g., a Microsoft Word template) and stored as a document instance. In one specific embodiment, report-writing software such as that available from a number of vendors such as SoftArtisans, Inc., Brookline, Mass., may be used to extract information from a data source (e.g., database) and/or generate custom document instances.

In one specific example, documents and other mailings may be generated using a database or similar data structure from which documents may be generated. In the example, a document template (e.g., in Microsoft Word format) may be stored and populated with input entered by the writer in an interface by a program. For instance, the commercial program product “WordWriter for Java” available from SoftArtisans may be used to create documents. The program takes a template and a set of data arrays, and generates resulting document instances. These data arrays may be created, for example, during a letter-writing session by accepting the writer's input within an interface and storing the input in the data array. In one example, the data array structure is programmed using Java array objects.

In the example, the provided template includes a set of fields in the template having certain predefined names. Data is passed through the array to the program, the data array indicating the names designated in the template which should be populated and the data with which it should be populated.

In one specific example using the WordWriter program, the following steps are performed:

1. String[ ] fieldNames={“name”, “street”, “city”, “state”, “zip”};

2. String[ ][ ] fieldValues={volunteer_name, volunteer_street, volunteer_city, volunteer_state, volunteer_zipcode};

3. wordwriter.open(template_file);

4. wordwriter.setRepeatBlock(filedNames, filedValues);

5. wordwriter.process( );

where:

Line 1 declares the field names that are present in the template

Line 2 assembles the writer's input to an array

Line 3 opens a template file into which the field values are inserted

Line 4 binds and matches field names and field values

Line 5 generates one or more output document instance(s)

Thus, multiple custom document instances may be created. Although the WordWriter program may be used, it should be appreciated that any program may be used that extracts data values and generates custom document instances, and the invention is not limited to any particular program.

After generation, documents may be stored, printed, e-mailed, or any other type of actions. In one example, the user is permitted to print, locally to his/her computer system, the documents along with any necessary items such as envelopes, cards, or other materials. For instance, in the case of a fundraising program for a particular charity, there may be other documents that accompany the correspondence such as descriptions of the charity, pledge cards, or other standard material that must be sent by the writer to any recipients. Alternatively, the documents may be sent to the organization and the organization or other third party may be responsible for sending out the correspondence. At block 410, process 400 ends.

FIG. 5 shows an example user interface 500 according to one embodiment of the present invention. In one embodiment, interface 500 may be displayed in a browser window (e.g., window 502) of a general-purpose computer as discussed above with reference to FIG. 1. As a preliminary step, interface 500 may include a login interface (not shown) having fields in which a user may enter a user name and password. When entered, the user may select a sign-in control (e.g., a button) that invokes a login procedure within the correspondence management system.

Thereafter, interface 500 may be presented to a user such as a writer of a document. Such an interface 500 may be presented, for example, using HTML forms, Windows forms, or any other suitable method for inputting and displaying data. As discussed above, a user interface may be developed using the well-known .NET framework. In one embodiment, interface 500 is created using Windows forms and the ASP.NET framework (Active Server Pages) available from the Microsoft Corporation. Although various aspects of the invention may be developed using .NET and/or Active Server Pages, it should be appreciated that any programming language (e.g., Java, JavaScript), framework (e.g., J2EE), or environment may be used, and the invention is not limited to any particular implementation.

As shown in FIG. 5, instructions 501 may be presented to the writer instructing them, for example, of the purpose of the correspondence. For instance, in the case of a fundraising activity, there may be one or more details regarding the activity that the organization (e.g., a fundraising organization) may wish to convey to a recipient of the correspondence. Instructions 501 may include one or more portions of the document having text (e.g., text 502) describing the activity. This text may be, for example, text that the organization has previously approved for inclusion in any correspondence relating to the activity. According to one embodiment, this text may be “frozen” so that the writer cannot change the content. However, in another example, the writer may be permitted to change the text to make the correspondence more personalized. After the writer has reviewed the instructions and example text, the writer may proceed to determine recipients of the correspondence by selecting control 503 (e.g., a button).

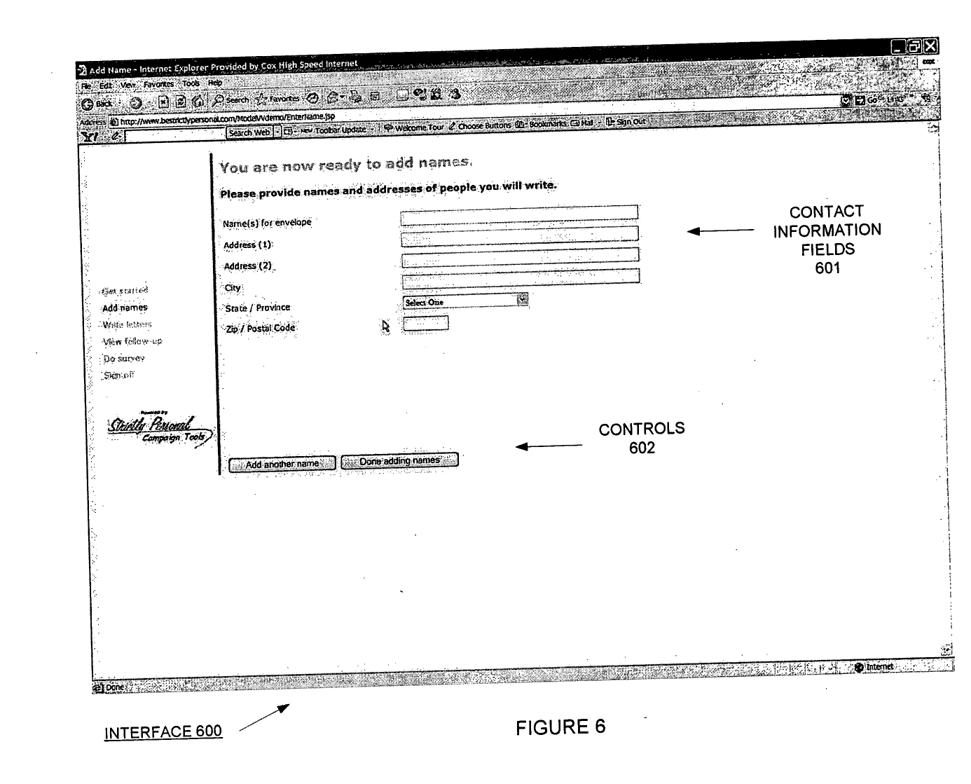

FIG. 6 shows an example user interface 600 according to one embodiment of the present invention. In particular, interface 600 may include one or more contact information fields 601 for inputting recipients of the correspondence. In one example, the contact information of the recipients, when input, may be saved to a database (e.g., database 208), and used to generate the correspondence, when created. In addition to manual input, the writer may be presented a list (not shown) of recipients previously stored in the database. These previously-stored recipients, for example, may be people to whom the writer had previously generated correspondence.

Controls 602 permit the writer to add additional recipients or to finish adding recipients to receive the current correspondence being generated. When the writer is finished entering recipients, the writer may begin to generate individualized personal correspondence for each recipient.

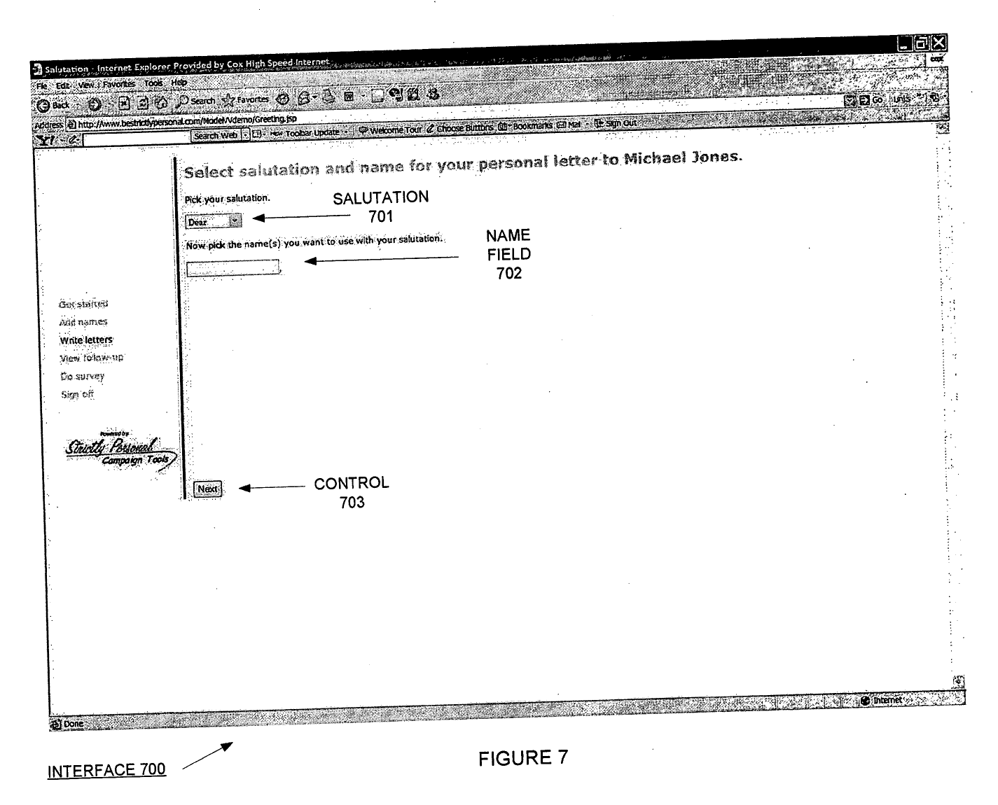

FIG. 7 shows one such interface 700 for generating individualized personal correspondence according to one embodiment of the present invention. According to one embodiment of the present invention, documents such as correspondence are generated in portions. These portions may include, for example, information provided by the organization, such as information regarding a particular activity (e.g., fundraising activity) and portions provided by the writer. These portions provided by the writer are, in one example, individualized personal for each recipient with whom the writer has a personal relationship. Because the correspondence being generated includes individualized personal information, the recipient may be more likely to contribute and/or participate in the activity, as it is realized that as the amount of personalization in correspondence increases, the level of participation in the activity by the recipient also increases.

To this end, interface 700 may include one or more fields that the writer may personalize to each recipient. For instance, interface 700 may include a salutation 701 and name field 702 that may be customized based on the existing relationship between the writer and recipient. For example, if the recipient has a surname or nickname used by the writer, the writer may prefer to use this name rather than a more formal name. When entry of fields 701, 702 are complete, the writer may select control 703 to proceed to draft another portion of the correspondence.

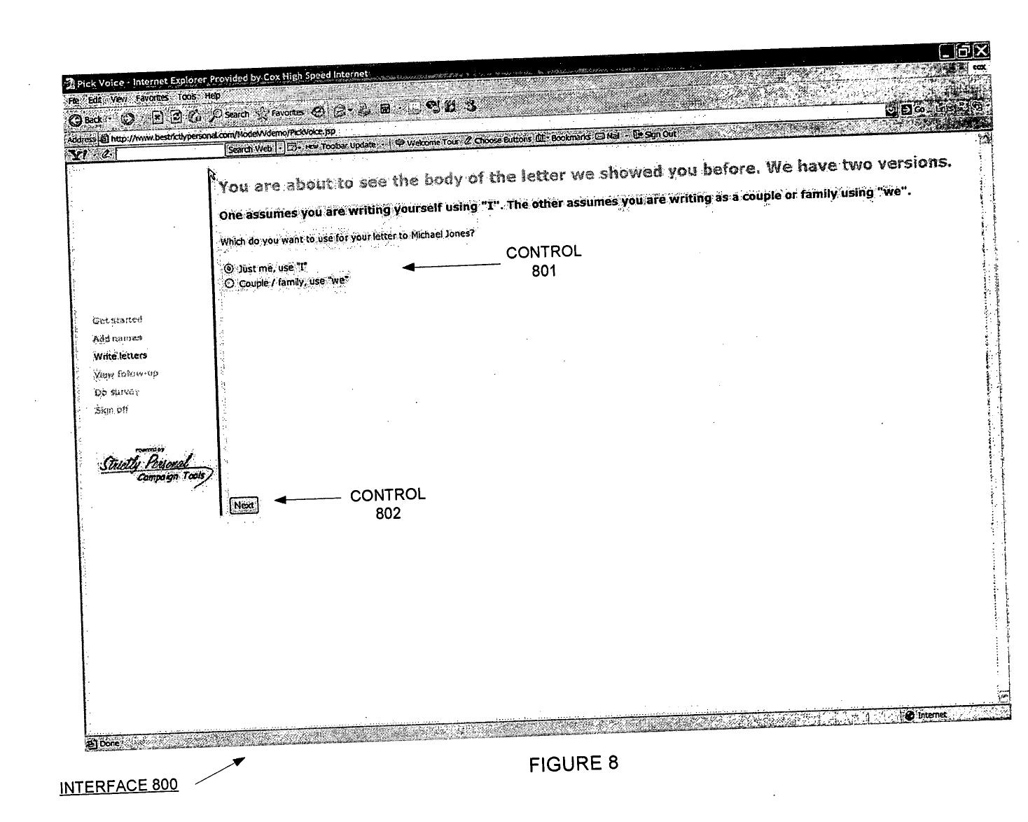

FIG. 8 shows another interface 800 for generating individualized personal correspondence according to one embodiment of the present invention. Notably, interface 800 may include a control 801 that permits the writer to change the voice used in the correspondence. More particularly, control 801, when selected, may change the voice used in the correspondence from a single person (“I”) to being from multiple people (“we”). The ability to easily change the voice of the correspondence is useful when a personal relationship extends from multiple people to the recipient, and therefore, a method is provided for the user to change the voice of the correspondence. Further, by changing the voice of the correspondence, one or more portions of the correspondence provided by the organization may be changed as a result.

More particularly, the voice of previously-approved portions of the correspondence may be changed in response to the activation of control 801. This may be accomplished, for example, by providing, by the organization, different versions of the previously-approved portions that are associated with each voice that can be used. Alternatively, a program may be used that analyzes the voice used in the correspondence, and changes the voice upon activation of control 801. Upon selection of the proper voice for the correspondence, the writer may proceed to prepare the next portion of the correspondence by selecting control 802.

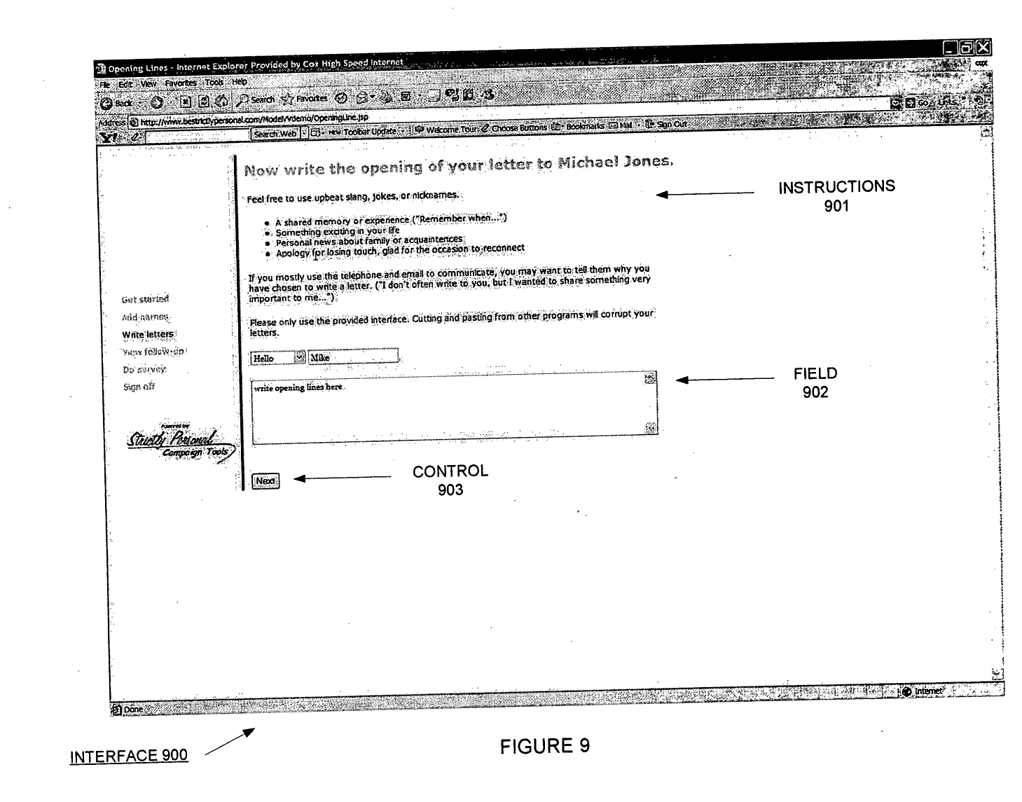

FIG. 9 shows another interface 900 for generating individualized personal correspondence according to one embodiment of the present invention. Notably, interface 900 may include instructions for the writer to assist him/her for developing individualized personal content. Specifically, interface 901 may include instructions 901 for completing a individualized personal portion of text, such as an opening line in a letter or other correspondence. The writer is permitted to enter the individualized personal portion of text in a field 902, which, when submitted, may be stored in a database (e.g., database 208). Interface 900 may also include a control 903, when selected, causes text in field 902 to be saved to a database. Further, the writer may then proceed to prepare a further portion of the correspondence in response to the selection of control 903.

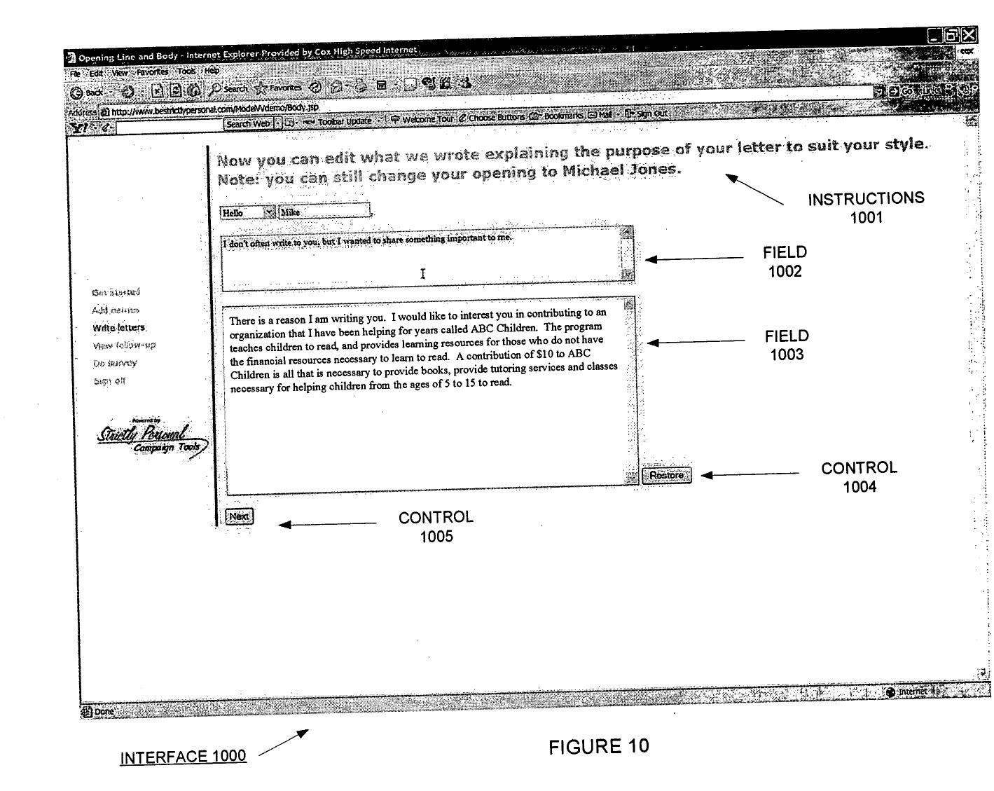

FIG. 10 shows another interface 1000 for generating individualized personal correspondence according to one embodiment of the present invention. In interface 1000, the writer may be presented an interface through which he/she prepares another portion of the correspondence. To this end, interface 1000 may include instructions 1001 that assists the writer in preparing the portion of the correspondence. In the case shown in FIG. 10, the writer is permitted to review a portion of text approved by the organization. In one embodiment, this text may be displayed in a field (e.g., field 1003) which can be edited by the writer.

In another embodiment, one or more portions of this text may be designated as being uneditable by the user. That is, the writer is not permitted to edit certain designated text. In another variation, there may be one or more rules that restrict editing of text in certain ways. For example, a user may be permitted to raise a suggested gift level (e.g., from $100 to $500), but not lower the gift amount (e.g., from $100 to $50). This uneditable portion may be, for example, all of the text (e.g., as presented in a field) provided by the organization, or a subset of text. Interface 1000 may also include a control 1004 that permits the writer to revert back to the default text as provided by the program.

Also, interface 1000 may display previously-generated portions of the correspondence, allowing the writer to prepare further sections while reviewing the previous portions. The writer may be permitted to revise these earlier-generated portions as the need arises in interface 1000. Interface 1000 may display these previously-generated portions in one or more fields (e.g., field 1002), having content that can be edited by the writer.

Interface 1000 may also include a control 1005 that, when selected, causes the created and/or edited portions to be saved to a database. Selection of control 1005 may also cause another interface to be generated to allow the writer to prepare a further portion of the correspondence.

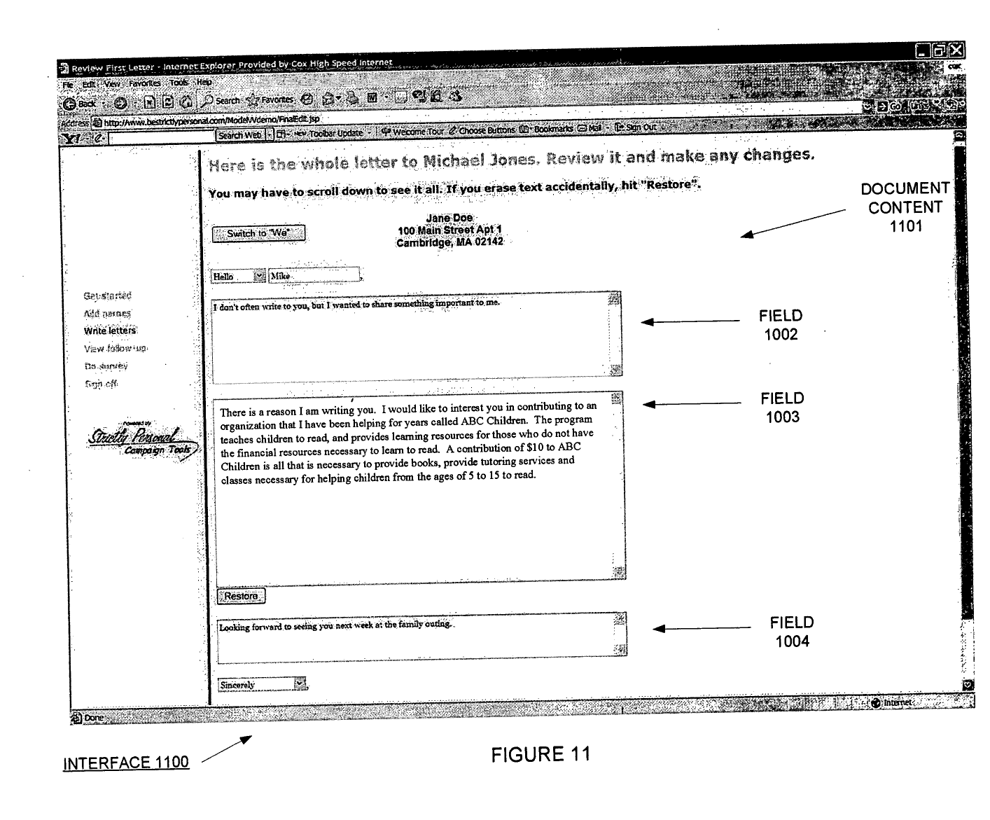

FIG. 11 shows another interface 1100 for generating individualized personal correspondence according to one embodiment of the present invention. Specifically, interface 1100 displays the created content 1101 (e.g., portions of the correspondence) that may be used to create the final version of the correspondence. This content 1101 may be presented to the writer for final review, prior to generating the document. Interface 1100 may include one or more fields (e.g., fields 1002-1004) that permit the writer to make any final edits to the document. When the document is reviewed and completed by the writer, the writer may select a control (not shown) which causes the final version of the portions to be saved. Thereafter, the writer may be permitted to create another individualized personal correspondence to another recipient, or if the current correspondence is the last correspondence to be generated, the program may begin the generation process (e.g., at block 409 of FIG. 4).

According to one aspect of the present invention, to save additional time and effort on behalf of the writer in creating further correspondence, certain fields may be populated with content provided in a previously-created correspondence. Because correspondence to multiple recipients may be created serially, it may be beneficial for the writer to continue with the previously-generated content, and revise particular portions, as necessary. Such previously-created portions may be retrieved from a database by the program and displayed to the writer when work is required on a corresponding portion of the new correspondence. In particular, a program may retrieve the relevant portion of text previously entered by the writer in a previous correspondence, and display the previously-entered text in a field of an interface displayed to the writer. Thereafter, the writer may edit or reuse this previously-entered text as necessary.

Although various embodiments of user interfaces as described above with reference to FIGS. 5-11, it should be appreciated that these interfaces are merely examples, and that the invention is not limited to the specific examples presented herein. Further, the invention is not limited to any particular combination of features within any interface, and it should be appreciated that various aspects of the invention may be implemented in any interface or interfaces, using any user input or display techniques either known or hereinafter developed.

Further, according to another aspect of the present invention, a workflow management tool is provided which automates many of the tasks involved in certain tasks related to the correspondence, such as follow-up, reminders, among others. According to one aspect of the present invention, it is realized that much time and effort is involved by staff of an organization in the management of the correspondence-creation process. According to one embodiment, a system is provided for managing the correspondence creation and follow-up process. In a particular example, a system is provided for managing correspondence and its related tasks, the system including one or more automated triggers and alerts that allow an organization to manage the correspondence-writing effort with minimal staff intervention. Further, an audit trail is created, as the system is adapted to store the status of tasks performed by various roles in the activity (e.g., writer, staff, recipient, etc.).

To this end, a system (e.g., system 201) may store the status of correspondence activities in a database (e.g., database 208). Triggers may be created that, based on the status of the correspondence activity and a rule created attached to that activity, may cause an event generator to generate an event. For instance, a rule may be defined in the system that requires a reminder message to be sent to a writer to follow up with a recipient. This message may be sent at a defined period of time after which the correspondence is sent. When the correspondence is sent, this may cause the trigger to be created for the particular writer/recipient instance, and this trigger may be stored in the database. An event generator may periodically determine if and when triggers are “triggered” based on, in one example, the time at which the trigger was created. For instance, the sending of a document may cause a trigger to be created with a timestamp indicating the time at which the document was sent. The trigger may be triggered according to a rule (e.g., send a reminder e-mail after two weeks after the document was sent).

Triggering of a trigger may cause an event to be created. As a result of an event, one or more actions may be taken, such as the sending of an e-mail, phone message, text message, postcard, etc. Such events may also be caused by a change in status in an activity (e.g., a recipient has made a donation). The message may include, for example, reminder messages indicating that one or more actions need to be taken, status updates indicating a status of the activity, thank-you messages to writers, recipients for actions taken (e.g., the sending of correspondence, donations received, etc.), and other types of messages that assist in organizing the correspondence and follow-up effort.

Also, there may be a further action performed by a user (e.g., a writer, staff, administrator, recipient, etc.) that may cause some triggers to be inactive. For instance, if the writer follows up with a recipient within two weeks after the document was sent, the trigger is disabled, and a reminder e-mail to the writer is not sent. As a result of the follow-up being performed, a status indicator may be set in the database that causes the trigger not to be activated, and therefore an e-mail is not sent.

Numerous other examples of triggers, events, and messages may be created by such a correspondence management system, and it should be appreciated that the invention is not limited to any particular types. Rather, any other types of triggers, events, and messages may be created.

In addition, this invention is not limited in its application to the details of construction and the arrangement of components set forth in the previous description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Use of ordinal terms such as “first”, “second”, “third”, “a)”, “b)”, “c)”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. In a computer system, a computer-based method for creating a document, the method comprising acts of:
a) providing, to a user, an interface that allows the user to create at least one first content portion;
b) providing, by an organization, at least one second content portion; and
c) generating the document including the at least one first content portion and at least one second content portion.

2. The method according to claim 1, further comprising an act of collecting content from the user in a sequence of steps.

3. The method according to claim 2, wherein the act of collecting content further comprises collecting the content in a linear sequence of steps.

4. The method according to claim 1, wherein the document is a letter, and the method further comprises an act of sending, by the organization, the letter to a recipient.

5. The method according to claim 1, further comprising an act of permitting the user to print the document at a computer system.

6. The method according to claim 1, wherein the acts a) through c) are performed by a computer system coupled to a communications network.

7. The method according to claim 1, further comprising an act of designating the at least second portion as unchangeable by the user.

8. The method according to claim 1, further comprising an act of storing the at least first content portion in a database.

9. The method according to claim 1, wherein the at least one second portion includes a portion of text written in a first voice, and wherein the method further comprises an act of permitting the user to change the first voice to a second voice.

10. The method according to claim 9, wherein the at least one second portion further comprises a portion of substantive content, and wherein a changing of the first voice to the second voice does not change the portion of substantive content.

11. The method according to claim 1, wherein the act of generating does not include an act of modifying the document after the act of generating.

12. The method according to claim 8, further comprising an act of retrieving the at least one first content portion from the database for use in a subsequent document.

13. The method according to claim 1, wherein the computer system includes a first computer system operated by the user, and wherein the method further comprises an act of transmitting the document to the organization.

14. The method according to claim 13, further comprising acts of printing and mailing the document by the organization.

15. The method according to claim 1, wherein the computer system includes a first computer system operated by the user, and wherein the method further comprises an act of printing the document by the first computer system, and mailing, by the user, the document to a recipient.

16. The method according to claim 15, further comprising an act of generating an event to the organization indicating that the document has been mailed.

17. The method according to claim 1, further comprising an act of storing a status of an action required by at least one of the organization, the user, and a recipient of the document.

18. The method according to claim 17, further comprising an act of generating an event based on the status of the action required.

19. The method according to claim 18, wherein the act of generating an event further comprises an act of sending, to the at least one of the organization, the user, and the recipient of the document, an indication of the status of the action required.

20. The method according to claim 19, wherein the act of sending an indication includes an act of sending an e-mail including the indication.

21. The method according to claim 1, wherein the act a) of providing further comprises an act of presenting an example content portion that may be edited by the user to create the at least one first content portion.

22. The method according to claim 1, wherein the at least one first content portion includes information personal to a relationship of the user to a recipient of the document.

23. The method according to claim 8, further comprising acts of retrieving the at least one first content portion from the database, inserting the at least one first content portion in a field of a template, and storing an instance of the template, the instance including that at least one first content portion.

24. A computer-readable medium having computer-readable signals stored thereon that define instructions that, as a result of being executed by a computer, instruct the computer to perform a method for creating a document, the method comprising acts of:
a) providing, to a user, an interface that allows the user to create at least one first content portion;
b) providing, by an organization, at least one second content portion; and
c) generating the document including the at least one first content portion and at least one second content portion.

25. The computer-readable medium according to claim 24, wherein the method further comprises an act of collecting content from the user in a sequence of steps.

26. The computer-readable medium according to claim 25, wherein the act of collecting content further comprises collecting the content in a linear sequence of steps.

27. The computer-readable medium according to claim 24, wherein the document is a letter, and the method further comprises an act of sending, by the organization, the letter to a recipient.

28. The computer-readable medium according to claim 24, wherein the method further comprises an act of permitting the user to print the document at a computer system.

29. The computer-readable medium according to claim 24, wherein the acts a) through c) are performed by a computer system coupled to a communications network.

30. The computer-readable medium according to claim 24, wherein the method further comprises an act of designating the at least second portion as unchangeable by the user.

31. The computer-readable medium according to claim 24, wherein the method further comprises an act of storing the at least first content portion in a database.

32. The computer-readable medium according to claim 24, wherein the at least one second portion includes a portion of text written in a first voice, and wherein the method further comprises an act of permitting the user to change the first voice to a second voice.

33. The computer-readable medium according to claim 32, wherein the at least one second portion further comprises a portion of substantive content, and wherein a changing of the first voice to the second voice does not change the portion of substantive content.

34. The computer-readable medium according to claim 24, wherein the act of generating does not include an act of modifying the document after the act of generating.

35. The computer-readable medium according to claim 31, wherein the method further comprises an act of retrieving the at least first content portion from the database for use in a subsequent document.

36. The computer-readable medium according to claim 24, wherein the computer system includes a first computer system operated by the user, and wherein the method further comprises an act of transmitting the document to the organization.

37. The computer-readable medium according to claim 36, wherein the method further comprises acts of printing and mailing the document by the organization.

38. The computer-readable medium according to claim 24, wherein the computer system includes a first computer system operated by the user, and wherein the method further comprises an act of printing the document by the first computer system, and mailing, by the user, the document to a recipient.

39. The computer-readable medium according to claim 38, wherein the method further comprises an act of generating an event to the organization indicating that the document has been mailed.

40. The computer-readable medium according to claim 24, wherein the method further comprises an act of storing a status of an action required by at least one of the organization, the user, and a recipient of the document.

41. The computer-readable medium according to claim 40, wherein the method further comprises an act of generating an event based on the status of the action required.

42. The computer-readable medium according to claim 41, wherein the act of generating an event further comprises an act of sending, to the at least one of the organization, the user, and the recipient of the document, an indication of the status of the action required.

43. The computer-readable medium according to claim 42, wherein the act of sending an indication includes an act of sending an e-mail including the indication.

44. The computer-readable medium according to claim 24, wherein the act a) of providing further comprises an act of presenting an example content portion that may be edited by the user to create the at least one first content portion.

45. The computer-readable medium according to claim 24, wherein the at least one first content portion includes information personal to a relationship of the user to a recipient of the document.

46. The computer-readable medium according to claim 31, wherein the method further comprises acts of retrieving the at least one first content portion from the database, inserting the at least one first content portion in a field of a template, and storing an instance of the template, the instance including the at least one first content portion.
